(19) United States
(12) Patent Application Publication
(10) Pub. No.: US 2012/0192148 A1
(43) Pub. Date: Jul. 26, 2012

(54) ELECTRONIC DEVICE AND METHOD FOR AUTOMATICALLY GENERATING MEASURING PROGRAMS

(75) Inventors: CHIH-KUANG CHANG, Tu-Cheng (TW); XIN-YUAN WU, Shenzhen City (CN); JIN-GANG RAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/287,136

(22) Filed: Nov. 2, 2011

(30) Foreign Application Priority Data
Jan. 20, 2011 (CN) 201110023852.9

(51) Int. Cl. G06F 9/44

(52) U.S. Cl. 717/107

(57) ABSTRACT

An electronic device and method of automatically generating measuring programs receives a design document of a product, obtains keywords from the design document, and searches graphic element data and dimension data indexes according to the keywords. Graphic elements are located according to the dimension data indexes. One or more measuring points for each of the graphic elements are obtained by dividing each graphic element into one or more sections according to the graphic element data and a predetermined dividing number, and a single measuring program is generated according to the measuring points.

### BACKGROUND

1. Technical Field

Embodiments of the present disclosure relate to devices and methods of product measurement, and more particularly to an electronic device and a method for automatically generating a measuring program.

2. Description of Related Art

In manufacturing, many products are measured by measuring machines. A measuring machine may obtain a design document or an image of a product, and take measurements of the product using the design document or the image under the control of an electronic device, such as a computer, which is installed with a measuring program. The design document or the image of the product may include only graphic elements, such as points, lines, planes, and circles. Thus, the measurement of the product may be simply measurements of the graphic elements.

When a measuring machine measures a product, one or more measuring points on a graphic element of a design document or an image of the product need to be selected. Originally, an engineer would manually select the measuring points on the graphic element. In addition, the measuring program, which is installed in the electronic device and used to take measurements on the product, is also programmed manually by the engineers according to the selected measuring points. Errors may happen in the selection of the measuring points and in programming the measuring program, and measurement times are generally longer.

### BRIEF DESCRIPTION OF THE DRAWINGS

FIG. 1 is a block diagram of one embodiment of an electronic device including a measuring program generation system.

FIG. 2 is a block diagram of one embodiment of function modules of the measuring program generation system of FIG. 1.

FIG. 3 is a flowchart of one embodiment of a method for automatically generating a measuring program.

FIG. 4 is an example of a design document having a CAD format.

FIG. 5 is an example of a design document having a text format.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

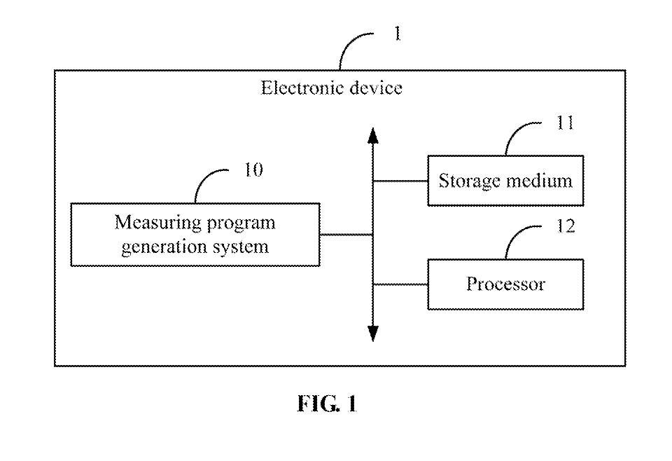

FIG. 1 is a block diagram of one embodiment of an electronic device 1 including a measuring program generation system 10. In the embodiment, the electronic device 1 further includes a non-transitory storage medium (storage medium 11), and at least one processor 12. Depending on the embodiment, the storage medium 11 may be a hard disk drive, a compact disc, a digital video disc, a tape drive, or other suitable storage mediums.

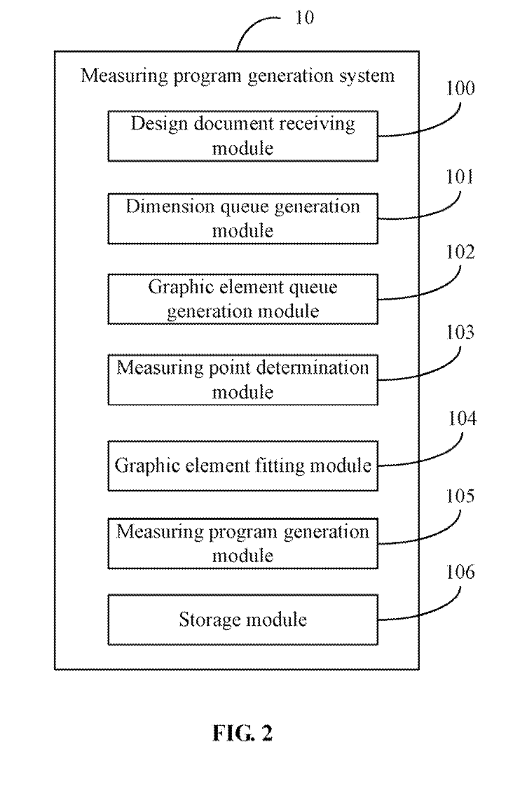

The measuring program generation system 10 includes a number of function modules (depicted in FIG. 2). The function modules may comprise computerized code in the form of one or more programs that are stored in the storage medium 11. The computerized code includes instructions that are executed by the at least one processor 12, to automatically select measuring points on the graphic elements of a design document of a product, and generate a measuring program for measuring the product according to the measuring points.

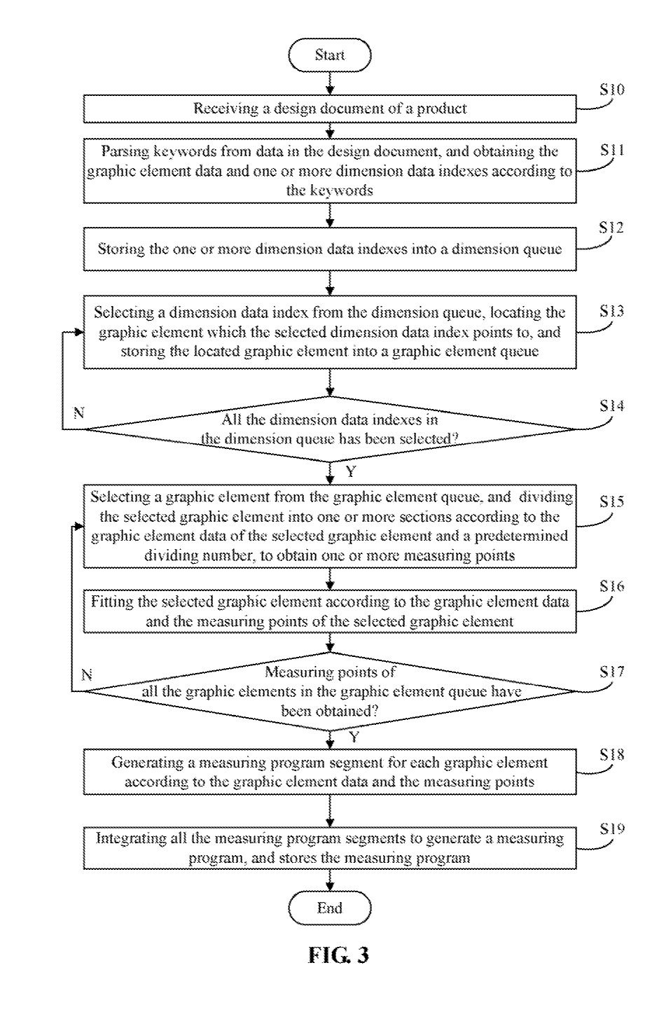

FIG. 2 is a block diagram of one embodiment of the function modules of the measuring program generation system 10. In one embodiment, the measuring program generation system 10 may include a design document receiving module 100, a dimension queue generation module 101, a graphic element queue generation module 102, a measuring point determination module 103, a graphic element fitting module 104, a measuring program generation module 105, and a storage module 106. The function modules 100-106 may provide the following functions (as illustrated in FIG. 3).

FIG. 3 is a flowchart of one embodiment of a method of automatically generating measuring programs. Depending on the embodiment, additional blocks may be added, others removed, and the ordering of the blocks may be changed.

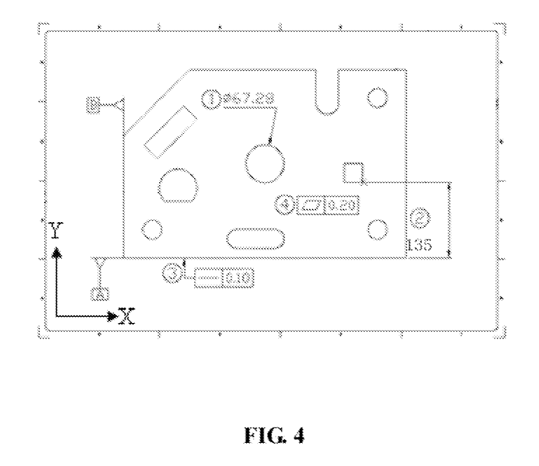

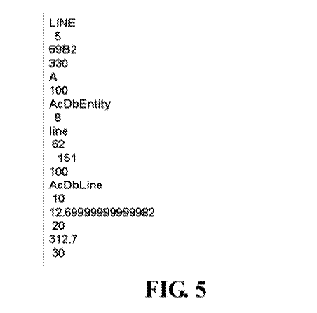

In block S10, the design document receiving module 100 receives a design document of a product from the storage medium 11. It may be understood that, the design document is a graphic document which uses graphic elements, such as, points, lines, planes, circles, to describe structure and modeling of the produce. If the design document is in a CAD format, as in the example shown in FIG. 4, the design document is converted into a text format, as the example FIG. 5 shows.

In block S11, the design document receiving module 100 parses keywords from the design document. The design document may include graphic element data of and dimension data of each graphic element in the design document. A graphic element may be a point, a line, a circle, or a plane, for example. The graphic element data defines positional coordinates of the graphic elements, and may include, but is not limited to, point data, line data, circle data, and plane data. The point data may be the coordinates of a point, the line data may be the respective coordinates of the starting point and the ending point of a line, for example. In the present embodiment, an indicator label “point” may be attached to the point data, an indicator label “line” may be attached to the line data, for example, to indicate the data types of the graphic element data. As implied by the name, the dimension data includes data regarding the dimensions of each of the graphic elements of the design document. In the same way, an indicator label “dimension” may be attached to the dimension data. The design document receiving module 100 parses the design document for such indicator labels as keywords.

Also in block S11, the design document receiving module 100 obtains the graphic element data and one or more dimension data indexes according to the keywords. In the present embodiment, the dimension data relating to a graphic element includes not only the dimensional data itself, but also a dimension data index pointing to the graphic element from which the dimensional data has been taken. For example, the dimension data of a line “L1” may include the length “a” and the straightness “b” of the line “L1”, and further include a dimension data index, such as “\textcircled{1}”. The dimension data of a line “L2” may include the length “c” and the straightness “d” of the line “L2”, and further include a dimension data index, such as “\textcircled{2}”. Thus, it may be understood that, the graphic element line “L1” whose length is “a” and straightness is “b” can be located using the dimension data index “\textcircled{1}”. Furthermore, the graphic element line “L2” whose length is “c” and straightness is “d” can be located using the dimension data index “\textcircled{2}”.

In block S12, the dimension queue generation module 101 stores the one or more dimension data indexes into a dimension queue. The dimension queue may be stored in the storage medium 11 of the electronic device 1.

In block S13, the graphic element queue generation module 102 selects a dimension data index from the dimension queue, locates the graphic element corresponding to the selected dimension data index, and stores the located graphic element into a graphic element queue. In one embodiment, the selection of the dimension data may be at random. The graphic element queue is also stored in the storage medium 11 of the electronic device 1.

In block S14, the graphic element queue generation module 102 determines if all of the dimension data indexes in the dimension queue have been selected. Block S15 is implemented if all of the dimension data indexes in the dimension queue have been selected. Otherwise, block S13 is repeated if any of the dimension data indexes in the dimension queue has not been selected.

In block S15, the measuring point determination module 103 selects a graphic element from the graphic element queue, and divides the selected graphic element into one or more sections according to the graphic element data of the selected graphic element and a predetermined dividing number, to obtain one or more measuring points for the selected graphic element. For example, If the selected graphic element is a point, it is obvious that the measuring point is the point itself. If the selected graphic element is a line, and the predetermined dividing number is N, the measuring point determination module 103 divides the line into (N-1) sections to obtain N measuring points such as (MP1.x, MP1.y, MP1.z), (MP2.x=MP1.x+M.x, MP2.y=MP1.y+M.y, MP2.z=MP1.z+M.z), . . . (MP(N-1).x=MP(N-2).x+M.x, MP(N-1).y=MP(N-2).y+M.y, MP(N-1).z=MP(N-2).z+M.z), and (MPN.x, MPN.y, MPN.z), where (MP1.x , MP1.y, MP1.z) and (MPN.x, MPN.y, MPN.z) are the respective starting point and the ending point of the line, and M.x=(MPN.x-MP1.x)/(N-1), M.y=(MPN.y-MP1.y)/(N-1), and M.z=(MPN.z-MP1.z)/(N-1). If the selected graphic element is a circle, and the predetermined dividing number is N, the measuring point determination module 103 divides the circle into (N-1) sections to obtain N measuring points such as (MP1.x=Center.x-R, MP1.y=Center.y, MP1.z=Center.z), (MP2.x=Center.x-R*Cosβ, MP2.y=Center.y-R*Sinβ, MP2.z=Center.z), (MP3.x=Center.x-R*Cos2β, MP3.y=Center.y-R*Sin2β, MP3.z=Center.z), . . . and (MPN.x=Center.x-R*Cos(N-1)β, MPN.y=Center.y-R*Sin(N-1)β, HT2.z=Center.z), where (Center.x, Center.y, Center.z) is the center point of the circle, and R is the radius of the circle.

In block S16, the graphic element fitting module 104 fits the selected graphic element using the graphic element data and the measuring points of the selected graphic element by the least square method. The purpose of fitting is to identify the graphic element of which the measuring points have been obtained.

In block S17, the graphic element fitting module 104 determines if the measuring points of all the graphic elements in the graphic element queue have been obtained. In one embodiment, the determination is made according to the fitting of the graphic elements. If all the graphic elements in the graphic element queue have been correspondingly fitted, the graphic element fitting module 104 determines that the measuring points of all the graphic elements in the graphic element queue have been obtained, and then block S18 is implemented. Otherwise, if a graphic element in the graphic element queue does not have a corresponding fitted graphic element, the graphic element fitting module 104 determines that the measuring points of at least one graphic element in the graphic element queue have not been obtained, then block S15 is repeated.

In block S18, the measuring program generation module 105 generates a measuring program segment for each graphic element according to the graphic element data and the measuring points of the graphic element. It may be understood that, the measuring program segment of a graphic element is text that includes computerized code that when executed by a processor, measures the graphic element. One example of a measuring program segment may be:
S2=FEAT/LINE
   ACTUAL/0.57, 0.00, 0.88, 1.00, 0.00, 0.00, 5.41
   PTMEAS/CART, 0.57, −0.00, 0.86, 0.00, −1.00, 0.00
   PTMEAS/CART, 2.24, 0.00, 0.90, 0.00, −1.00, 0.00
   PTMEAS/CART, 4.01, 0.00, 0.89, 0.00, −1.00, 0.00
   PTMEAS/CART, 5.99, −0.00, 0.88, 0.00, −1.00, 0.00
   ENDMES

In block S19, the storage module 106 integrates all the measuring program segments to generate a single measuring program, and stores the single measuring program into the storage medium 11.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of automatically generating measuring programs, the method being performed by execution of computerized code by a processor of an electronic device, comprising:
receiving a design document of a product;
parsing keywords in the design document, obtaining graphic element data and one or more dimension data indexes from the design document according to the keywords, and storing the one or more dimension data indexes into a dimension queue;
selecting a dimension data index one by one from the dimension queue, locating the graphic element corresponding to the selected dimension data index, and storing the located graphic element into a graphic element queue;
selecting a graphic element from the graphic element queue one by one, and dividing the selected graphic element into one or more sections according to the graphic element data of the selected graphic element and a predetermined dividing number, to obtain one or more measuring points for the selected graphic element;
generating a measuring program segment for each graphic element according to the graphic element data and the measuring points of the graphic element; and
integrating all the measuring program segments to generate a measuring program, and storing the measuring program into the storage medium into a non-transitory storage medium.

2. The method according to claim 1, when the design document is in a CAD format, the method further comprising:
converting the CAD format into a text format.

3. The method according to claim 1, wherein the graphic element data and the dimension data is attached respectively by indicator label which indicates data type of the graphic element data and the dimension data, and the keywords are the indicator label.

4. The method according to claim 1, wherein the design document comprises the graphic element data and dimension data of each graphic element, and the dimension data of a graphic element comprises a dimension data index which points to the graphic element.

5. The method according to claim 4, wherein the graphic elements is a point, a line, a plane, and a circle.

6. The method according to claim 1, after obtaining one or more measuring points for the selected graphic element, the method further comprising:
fitting the selected graphic element according to the graphic element data and the measuring points of the selected graphic element using the least square method.

7. An electronic device, comprising:
a non-transitory storage medium;
at least one processor; and
one or more modules that are stored in the non-transitory storage medium; and are executed by the at least one processor, the one or more modules comprising instructions to:
receive a design document of a product;
parse keywords in the design document, obtain graphic element data and one or more dimension data indexes from the design document according to the keywords, and store the one or more dimension data indexes into a dimension queue;
select a dimension data index one by one from the dimension queue, locate the graphic element corresponding to the selected dimension data index, and store the located graphic element into a graphic element queue;
select a graphic element from the graphic element queue one by one, and divide the selected graphic element into one or more sections according to the graphic element data of the selected graphic element and a predetermined dividing number, to obtain one or more measuring points for the selected graphic element;
generate a measuring program segment for each graphic element according to the graphic element data and the measuring points of the graphic element; and
integrate all the measuring program segments to generate a measuring program, and storing the measuring program into the storage medium into the non-transitory storage medium.

8. The electronic device according to claim 7, when the design document is in a CAD format, the one or more modules further comprising instructions to:
convert the CAD format to a text format.

9. The electronic device according to claim 7, wherein the graphic element data and the dimension data is attached respectively by indicator label which indicates data type of the graphic element data and the dimension data, and the keywords are the indicator label.

10. The electronic device according to claim 7, wherein the design document comprises the graphic element data and dimension data of each graphic element, and the dimension data of a graphic element comprises a dimension data index which points to the graphic element.

11. The electronic device according to claim 10, wherein the graphic elements is a point, a line, a plane, and a circle.

12. The electronic device according to claim 7, after obtaining one or more measuring points for the selected graphic element, the one or more modules further comprising instructions to:
fit the selected graphic element according to the graphic element data and the measuring points of the selected graphic element using the least square method.

13. A non-transitory storage medium having stored thereon instructions that, when executed by a processor of an electronic device, causes the processor to perform a method of automatically generating measuring programs, wherein the method comprises:
receiving a design document of a product;
parsing keywords in the design document, obtaining graphic element data and one or more dimension data indexes from the design document according to the keywords, and storing the one or more dimension data indexes into a dimension queue;
selecting a dimension data index one by one from the dimension queue, locating the graphic element corresponding to the selected dimension data index, and storing the located graphic element into a graphic element queue;
selecting a graphic element from the graphic element queue one by one, and dividing the selected graphic element into one or more sections according to the graphic element data of the selected graphic element and a predetermined dividing number, to obtain one or more measuring points for the selected graphic element;
generating a measuring program segment for each graphic element according to the graphic element data and the measuring points of the graphic element; and
integrating all the measuring program segments to generate a measuring program, and storing the measuring program into the storage medium into a non-transitory storage medium.

14. The non-transitory storage medium according to claim 13, wherein the method further comprises:
converting the CAD format to a text format upon condition that the design document is in a CAD format.

15. The non-transitory storage medium according to claim 13, wherein the graphic element data and the dimension data is attached respectively by indicator label which indicates data type of the graphic element data and the dimension data, and the keywords are the indicator label.

16. The non-transitory storage medium according to claim 13, wherein the design document comprises the graphic element data and dimension data of each graphic element, and the dimension data of a graphic element comprises a dimension data index which points to the graphic element.

17. The non-transitory storage medium according to claim 16, wherein the graphic elements is a point, a line, a plane, and a circle.

18. The non-transitory storage medium according to claim 13, wherein the method further comprises:
fitting the selected graphic element according to the graphic element data and the measuring points of the selected graphic element using the least square method after obtaining one or more measuring points for the selected graphic element.
